(19) United States
(12) Patent Application Publication
(10) Pub. No.: US 2014/0150559 A1
(43) Pub. Date: Jun. 5, 2014

(54) ELECTROSTATIC PRESSURE SENSOR

(71) Applicant: Azbil Corporation, Tokyo (JP)

(72) Inventors: Takuya ISHIHARA, Tokyo (JP); Hidenobu TOCHIGI, Tokyo (JP)

(73) Assignee: AZBIL CORPORATION, Tokyo (JP)

(21) Appl. No.: 14/092,065

(22) Filed: Nov. 27, 2013

(30) Foreign Application Priority Data
Nov. 30, 2012 (JP) 2012-263689

(51) Int. Cl. G01L 9/12

(52) U.S. Cl. CPC G01L 9/12
USPC 73/718

(57) ABSTRACT

An electrostatic pressure sensor includes a diaphragm, a sensor pedestal, a cover plate, a stationary electrode, and a movable electrode. The cover plate is bonded to an outer peripheral portion of the diaphragm on the opposite side from the sensor pedestal to form a pressure introduction chamber in cooperation with the diaphragm. The cover plate has a pressure introducing hole that introduces a medium to be measured into the pressure introduction chamber from a direction that is perpendicular to a surface of the diaphragm. The pressure introducing hole is arranged so as to be positioned in a range of between 50.0% and 70.0% from the center of the diaphragm along a direction of the surface of the diaphragm, when the radius of the diaphragm is defined as 100%.

### CROSS REFERENCE TO RELATED APPLICATION

This application claims priority under 35 U.S.C. §119 to Japanese Patent Application No. 2012-263689, filed on Nov. 30, 2012, the entire content of which being hereby incorporated herein by reference.

### FIELD OF TECHNOLOGY

The present invention relates to an electrostatic pressure sensor provided with a pressure sensor chip having a diaphragm structure for detecting an electrostatic capacitance in accordance with the pressure of a medium being measured.

### BACKGROUND

Conventionally, pressure sensors of a diaphragm type for detecting a change in a pressure to be measured as a change in electrostatic capacitance have been broadly known. As one example of this pressure sensor there is a known electrostatic pressure sensor wherein a filter is placed on a connecting hole between a vacuum chamber and a diaphragm vacuum gauge, to prevent non-reacted substances, byproduct substances, particulates, and the like, from getting into a vacuum gauge from a vacuum chamber, to prevent deposition components such as byproducts and particles from adhering to and being deposited onto the pressure-sensitive diaphragm that structures the diaphragm sensor. See, for example, Japanese Unexamined Patent Application Publication H10-153510 (“the JP '510”).

The electrostatic pressure sensor disclosed in the JP '510 can reduce the deposition, onto the diaphragm, of those deposition components that have high linearity of travel that are included in the medium being measured. However, due to the need to direct, to the diaphragm, the pressure of the medium that is being measured, it is impossible, using a filter, to exclude completely those components that will be deposited.

When a portion of the deposition components in the medium to be measured is deposited onto the diaphragm, the diaphragm flexes in one direction, producing zero-point shift (a movement of the zero point). That is, the deposited material that adheres to the diaphragm produces an internal stress that, depending on the composition thereof, is either a compressive stress or a tensile stress. This will cause the surface of the diaphragm, on the side that contacts the medium that is being measured, to either be compressed or be tensioned, disrupting the balance of forces in the direction of thickness of the diaphragm. As a result, the diaphragm flexes so as to be either convex on the side of the medium being measured, or convex on the side that is opposite of the medium being measured.

It is impossible to cause the deposits, which will vary depending on the medium to be measured, and the materials of the diaphragms to always match each other, and, microscopically, the arrangements of the atoms in the deposited substances and in the diaphragms rarely match perfectly, and thus the deposited substances that adhere to the diaphragm produce the compression or elongation described above. Given this, the flexure of the diaphragm becomes larger the greater the amount of the deposited substance that adhere to the diaphragm.

In an electrostatic pressure sensor, a pressure difference is detected based on the electrostatic that varies depending on the flexure of the diaphragm. If the diaphragm flexes due to a deposited substance adhering to the diaphragm, then a signal indicating that there is a pressure difference will be detected even in a state wherein there is no difference in pressure between the sides of the diaphragm, producing a zero-point error known as a “zero-point shift,” producing error in the pressure measurement. To avoid this error in the pressure measurement it is necessary to swap the electrostatic pressure sensor frequently, producing a problem with increased cost.

Given this, an electrostatic pressure sensor has in proposed wherein the central portion of the diaphragm is thinner than the peripheral edge portion, so that the rigidity of the central portion will be less than the rigidity of the peripheral edge portion, thereby suppressing flexure of the diaphragm caused through internal stresses of deposited materials. See, for example, Japanese Unexamined Patent Application Publication 2010-236949 (“the JP '949”).

The electrostatic pressure sensor disclosed in the JP '949 assumes that the deposited material forms a uniform film on the diaphragm. However, in practice the deposition of a film on the diaphragm is unavoidable, and actually the film deposition process will be one that produces a bias in the distribution of the film thickness due to the process materials, the processing conditions, the structure of the vacuum gauge, the position of the vacuum gauge, and so forth, so the aforementioned assumption is not satisfied in such a case. ALD (Atomic Layer Deposition) will be used as a specific example below, to illustrate the principles of ALD and conjectures regarding the factors that produce the bias in the distribution of the film thickness.

An electrostatic pressure sensor is used as a vacuum gauge, disposed within a chamber that is used in, for example, a semiconductor manufacturing process. In this semiconductor manufacturing process, ALD (Atomic Layer Deposition), which is used primarily to deposit an insulating film, is a deposition technique that assumes a surface absorption reaction, wherein the film is formed through producing surface reactions alternatingly between a raw material gas, known as a precursor gas, which includes an atomic element of the film to be deposited, and a reactive gas (which, in many cases, is an oxide material gas). For example, for the case of depositing an AlO film, the precursor gas is trimethyl aluminum and the reactive gas (the oxide material gas) is H₂O, O₃, or the like.

More specifically, in ALD, a cycle such as the following (A) through (D) is performed repetitively:

(A) The precursor gas is introduced into the chamber and caused to absorb onto the surface of a wafer.

(B) The precursor gas in excess of an atomic monolayer on the surface of the wafer is purged (removed) through either placing the chamber under vacuum or introducing an inert gas into the chamber.

(C) The reactive gas is introduced into the chamber and caused to react with the precursor gas.

(D) The reaction products and left over reactive gas are purged through either placing the chamber under vacuum or introducing an inert gas into the chamber.

In this way, in ALD it is possible to perform uniform deposition onto locations such as via holes that have high aspect ratios and complex three-dimensional structures on a wafer because film deposition on the atomic level is performed one-layer-at-a-time through a chemical reaction between the absorbed raw material gas and the reaction gas. Note, however, that the reaction surface is not only the wafer, but rather the film is deposited everywhere in the process chamber, including the vacuum gauge, which often leads to problems such as described above.

Conjectures regarding the factors that cause partially non-uniform layers to be deposited in ALD, which, in principle should deposit a uniform layer, will be explained next. It is known that if there is an inadequate purge in the film deposition onto the process wafer through ALD, the remaining gas will mix in the chamber, producing vapor-phase reactions, rather than surface reactions, producing undesirable reaction products, preventing the deposition of a good film.

Normally the vacuum gauge is disposed in the chamber, where the wafers that are subject to processing are located, but in a peripheral portion that is not the same place wherein the wafers are positioned, and in many cases the gas within the chamber is guided to the diaphragm through ducting. Because of this, it is can be assumed that the gas ventilation in the vicinity of the diaphragm is poor when compared with that over the wafer. Moreover, if, depending on the structure in the vicinity of the diaphragm, there is a region over a part of the wafer wherein the gas conductance (ease of flow) is poor, the ventilation of the gases in that region will be poor, preventing good film deposition, so it is anticipated that the film that is deposited on the diaphragm will be thinner when compared to regions wherein the conductance is good. Given this, it is well understood that in ALD there will be cases wherein the distribution of the film thickness on the diaphragm will be biased depending on the process materials, the processing conditions, the structure of the vacuum gauge, the position of the vacuum gauge, and the like, given that deposition of a film onto the diaphragm is, in theory, unavoidable.

In the electrostatic pressure sensor disclosed in the JP '949, the assumption is that the thickness of the film that is deposited on the diaphragm will be uniform, and thus when there are biases in the distribution of film thicknesses on the diaphragm, it becomes impossible to prevent flexure of the diaphragm, making it impossible to prevent the zero-point shift. In particular, when the gas conductance is good in the center portion of the diaphragm, where the electrode for detecting the pressure is disposed, and the gas conductance is poor at the outer peripheral portion of the diaphragm, then the film that is deposited in the central portion of the diaphragm will be that, producing a large moment through the film stress, producing a large zero-point shift.

The present invention is to solve the problem set forth above, and an aspect thereof is to provide an electrostatic pressure sensor that is able to suppress the zero-point shift, even when electrostatic pressure sensor is applied to a device that uses a film deposition technique that produces a bias in the distribution of film thicknesses on the diaphragm.

### SUMMARY

An electrostatic pressure sensor according to the present invention includes a diaphragm having a center portion that dislocates in accordance with a pressure of a medium to be measured, a sensor pedestal that secures a peripheral edge portion of the diaphragm, to form a reference vacuum chamber in cooperation with the diaphragm, a cover plate, bonded to an outer peripheral portion of the diaphragm on the opposite side from the sensor pedestal, to form a pressure introduction chamber in cooperation with the diaphragm, a stationary electrode that is formed on a surface of the sensor pedestal on the reference vacuum chamber side, and a movable electrode that is formed on a surface of the diaphragm on the reference vacuum chamber side, facing the stationary electrode. The cover plate has a pressure introducing hole that introduces the medium to be measured into the pressure introduction chamber from a direction that is perpendicular to the surface of the diaphragm. The pressure introducing hole is arranged so as to be positioned in a range of between 50.0% and 70.0% from the center of the diaphragm along a direction of the surface of the diaphragm, when the radius of the diaphragm is defined as 100%.

Moreover, in the first example structure of an electrostatic pressure sensor according to the present invention, the pressure introducing hole is arranged in a plurality of holes in positions on a circle that encompass the center of the diaphragm.

Moreover, in the first example structure of an electrostatic pressure sensor according to the present invention, the movable electrode includes a pressure sensitive-side movable electrode that is formed so that the center thereof is coincident with the center of the diaphragm, and a reference-side movable electrode that is formed so as to be to the outside of the pressure sensitive-side movable electrode. The stationary electrode includes a pressure sensing side stationary electrode that is formed so as to face the pressure sensing side movable electrode, and a reference side stationary electrode that is formed so as to face the reference side movable electrode.

Given the present invention, the pressure introducing holes are distributed so as to be in positions in the range of 50.0% through 70.0% from the center of the diagram along a direction of the surface of the diaphragm, which can mitigate the moment that is due to the film stress that is increased as the result of poor balance in the conductance (ease of flow) of the medium that is to be measured, thus enabling suppression of the zero-point shift even when the electrostatic pressure sensor is applied to a device that uses a film deposition technique that produces a bias in the film thickness distribution on the diaphragm, such as ALD.

### BRIEF DESCRIPTIONS OF THE DRAWINGS

FIG. 1 is a cross-sectional diagram illustrating the structure of an electrostatic pressure sensor according to an example according to the present invention.

FIG. 2 is a plan view diagram illustrating the arrangement of the pressure sensing side stationary electrode and the reference side stationary electrode formed on the sensor pedestal.

FIG. 3 is a diagram for explaining the operation of an electrostatic pressure sensor according to an example according to the present invention.

FIG. 4 is a diagram illustrating the relationship between the position of the pressure introducing holes and the rate of shift of the sensor output.

FIG. 5 is a cross-sectional diagram illustrating a structure of a conventional electrostatic pressure sensor.

FIG. 6 is a plan view diagram illustrating an example arrangement for the pressure introducing holes in an example according to the present invention.

FIG. 7 is another plan view diagram illustrating an example arrangement for the pressure introducing holes in an example according to the present invention.

### DETAILED DESCRIPTION

The inventors conceived of the ability to control flexure of the diaphragm, that is, to control the zero-point shift, through the ability to control the film thickness distribution on the diaphragm through controlling the conductance of the gas in the space over the diaphragm because a strong bending moment that produces flexure of the diaphragm is produced through film stress in the part wherein the film is deposited thickly on the diaphragm in an electrostatic pressure sensor. Specifically, the opening portion of the electrostatic pressure sensor, for introducing the pressure of the medium to be measured, is formed more toward the outside than the middle of the diaphragm. More specifically, a method is considered wherein, instead of a single opening portion that is formed at the position of the center of the diaphragm in the conventional electrostatic pressure sensor, a plurality of small opening portions, having the same total opening cross-sectional area as this opening portion, are arranged at positions on a circle surrounding the center of the diaphragm.

### EXAMPLES

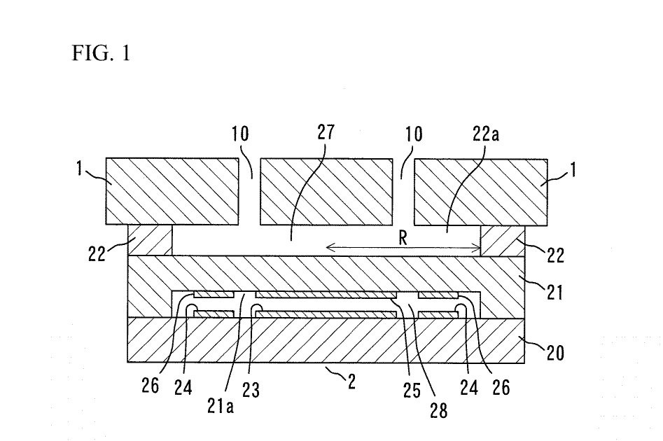

Forms for carrying out the present invention will be explained below in reference to the figures. FIG. 1 is a cross-sectional diagram illustrating the structure of an electrostatic pressure sensor according to an example according to the present invention. The electrostatic pressure sensor is structured from a cover plate 1, made from sapphire, which is a single crystal unit of aluminum oxide, and a pressure sensor chip 2 that is bonded to the cover plate 1. The pressure sensor chip 2 is structured from: a sensor pedestal 20 that is made from sapphire; a diaphragm 21 that is made from sapphire, bonded to the sensor pedestal 20; a spacer 22, made from sapphire, bonded to the diaphragm 21; a pressure sensing side stationary electrode 23, made from a conductor, such as platinum, or the like, formed on the sensor pedestal 20; a reference side stationary electrode 24, made from a conductor such as platinum, or the like, formed on the sensor pedestal 20; a pressure sensing side movable electrode 25, made from a conductor such as platinum, or the like, formed on the diaphragm 21, facing the pressure sensing side stationary electrode 23; and a reference side movable electrode 26, made from a conductor such as platinum, or the like, formed on the diaphragm 21, facing the reference side stationary electrode 24.

A spacer 22, wherein is formed a through hole 22a that is essentially circular in the plan view, is provided between the cover plate 1 and the diaphragm 21, forming a space 27 (hereinafter termed the “pressure introduction chamber”), which is essentially circular in the plan view, between the cover plate 1 and the diaphragm 21. Moreover, a hollow portion 21 a, which is essentially circular in the plan view, is provided in the surface of the diaphragm 21 on the sensor pedestal 20 side, forming a vacuum space 28 (hereinafter termed the “reference vacuum chamber”), which is essentially circular in the plan view, between the sensor pedestal 20 and the diaphragm 21.

The sensor pedestal 20 and the diaphragm 21 are bonded together by an aluminum oxide-based bonding material that, after bonding, is converted into sapphire. Similarly, the diaphragm 21 and the spacer 22 are bonded together through an aluminum oxide-based bonding material. Such a technique for bonding is described in detail in Japanese Unexamined Patent Application Publication 2002-111011, and thus detailed explanations are omitted here. Note that instead a spacer-shaped protrusion may be formed on the bottom portion of the cover plate 1 and the spacer 22 may be omitted.

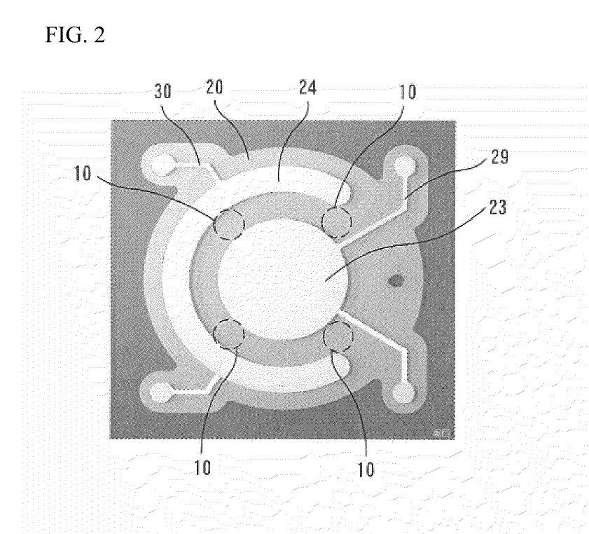

FIG. 2 is a plan view diagram illustrating the arrangement of the pressure sensing side stationary electrode 23 and the reference side stationary electrode 24 that are formed on the sensor pedestal 20. The pressure sensing side stationary electrode 23, which is essentially circular in the plan view, is formed on the surface of the sensor pedestal 20 on the reference vacuum chamber 28 side such that the center thereof is essentially coincident with the center of the diaphragm 21. The reference side stationary electrode 24, which is essentially a circular arc shape in the plan view, is formed on the surface of the sensor pedestal 20 on the reference vacuum chamber 28 side so as to be disposed on the outside of the pressure sensing side stationary electrode 23, in an essentially concentric circular shape. The pressure sensing side stationary electrode 23 is connected electrically through an interconnection 29 that is formed on the sensor pedestal 20, to a signal processing device (not shown) that is external to the sensor. Similarly, the reference side stationary electrode 24 is connected electrically through an interconnection 30 that is formed on the sensor pedestal 20, to a signal processing device.

The structure of the movable electrodes on the diaphragm 21 side is the same as that for the stationary electrodes. The pressure sensing side movable electrode 25, which is essentially circular in the plan view, is formed on the surface of the diaphragm 21 on the reference vacuum chamber 28 so as to face the pressure sensing side stationary electrode 23. The center of the pressure sensing side movable electrode 25 is essentially coincident with the center of the diaphragm 21. The reference side movable electrode 26, which is essentially a circular arc shape in the plan view, is formed on the surface of the diaphragm 21 on the reference vacuum chamber 28 so as to face the reference side stationary electrode 24. The reference side movable electrode 26 is disposed in a circle shape that is essentially concentric, to the outside of the pressure sensing side movable electrode 25. The pressure sensing side movable electrode 25 is connected electrically through an interconnection (not shown) that is formed on the diaphragm 21, to a signal processing device that is external to the sensor. Similarly, the reference side movable electrode 26 is connected electrically through an interconnection (not shown) that is formed on the diaphragm 21, to a signal processing device.

The pressure sensing side stationary electrode 23 and the pressure sensing side movable electrode 25 are highly sensitive to pressure, and fulfill the role of performing the pressure measurement. The reference side stationary electrode 24 and the reference side movable electrode 26 have low sensitivity to pressure, and fulfill the role of compensating for the permittivity between the electrodes.

A pressure introducing hole 10, formed so as to pass through the cover plate 1 in order to introduce the medium to be measured into the pressure introduction chamber 27, is formed in the cover plate 1 that is bonded to the pressure sensor chip 2, as described above. The details of this pressure introducing hole 10 will be described below. The spacer 22 between the cover plate 1 and the pressure sensor chip 2 is bonded through an aluminum oxide-based bonding material that is converted to sapphire after bonding.

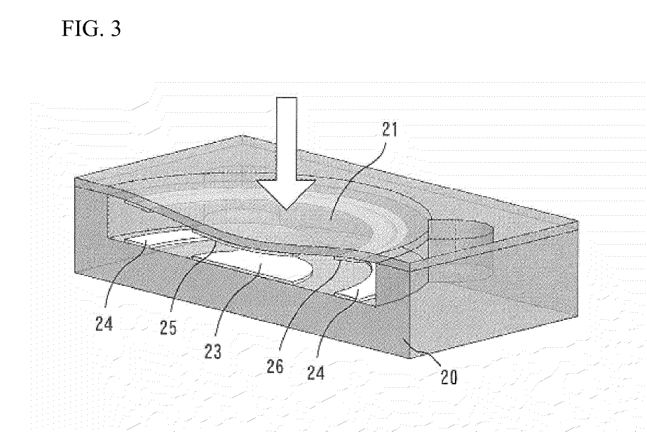

The operation of the electrostatic pressure sensor according to the present example will be explained next. FIG. 3 is a diagram for explaining the operation of the electrostatic pressure sensor. When the medium to be measured is introduced into the pressure introduction chamber 27 through the pressure introducing hole 10 from a direction that is perpendicular to the surface of the diaphragm 21 (the direction that is perpendicular to the surface of the diaphragm 21 in the examples in FIG. 1 and FIG. 3), the diaphragm 21 deforms in accordance with the pressure of the medium being measured, as illustrated in FIG. 3. When the electrostatic pressure sensor is used as a vacuum gauge in a semiconductor manufacturing process, the medium being measured is the gas within the chamber.

When the diaphragm 21 deforms, the distance between the sensor pedestal 20 and the diaphragm 21 (the height of the reference vacuum chamber 28) changes, changing the capacitance between the pressure sensing side stationary electrode 23 and the pressure sensing side movable electrode 25, and changing the capacitance between the reference side stationary electrode 24 and the reference side movable electrode 26. When the capacitance between the pressure sensing side stationary electrode 23 and the pressure sensing side movable electrode 25 is defined as Cx, and the capacitance between the reference side stationary electrode 24 and the reference side movable electrode 26 is defined as Cr, the sensor output K is calculated as per the following equation:

K=(Cx−Cr)/Cx (1).

A signal processing device, not shown, calculates the sensor output K through Equation (1), and converts the sensor output K (a capacitance value) into a pressure value, making it possible to measure the pressure of the medium being measured.

The pressure introducing holes 10 in the cover plate 1 will be explained next. In the present example, in order to control the conductance of the medium being measured within the pressure introduction chamber 27, a plurality of pressure introducing holes 10 are distributed in positions on a circle that surrounds the center of the diaphragm 21 (positions on a circle that has, as the center thereof, a point that is coincident with the center of the diaphragm 21), to control the distribution of the film thickness of the deposited material that adheres to the diaphragm 21. In the example in FIG. 2, the positions of the pressure introducing holes 10 that are formed in the cover plate 1 are shown by the dotted lines. In the example in FIG. 2, there are four pressure introducing holes 10.

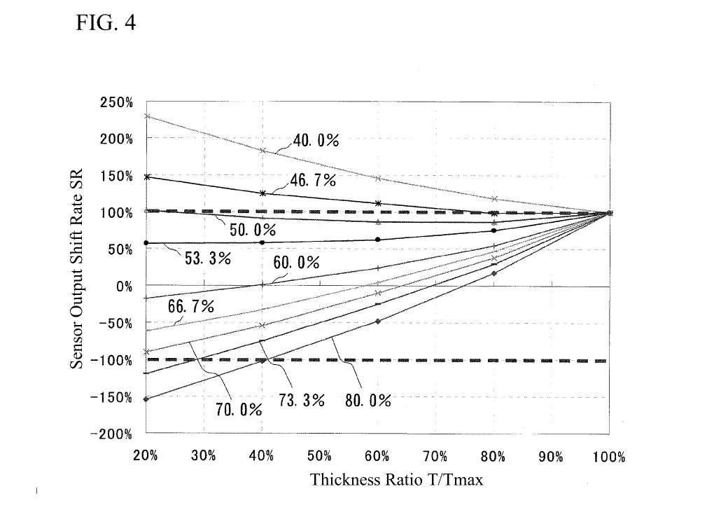

FIG. 4 is a diagram illustrating the relationship between the positions of the pressure introducing holes 10 and the proportion of shift of the sensor output. FIG. 4 was produced through simulating the rate of shift of the sensor output when the positions of the pressure introducing holes 10 were varied in a range between 40.0% and 80.0% from the center of the diaphragm 21 along a direction of the surface of the diaphragm 21 (a direction that is parallel to the surface of the paper in FIG. 2), with the radius of the diaphragm being defined as 100%. Here the rate of shift of the sensor output is calculated for the case wherein four pressure introducing holes 10 are provided on a circle that encompasses the center of the diaphragm 21. Note that, as is clear from the hollow portion 21a and the through hole 22a being essentially circular in the plan view, the diaphragm 21 that is exposed to the pressure introduction chamber 27 and the reference vacuum chamber 28 is essentially circular in the plan view. The radius of the diaphragm 21 refers to the distance R from the center of the diaphragm 21 to the inner wall of the spacer 22, as illustrated in FIG. 1. The horizontal axis in FIG. 4 shows the film thickness Tmax at the place wherein the deposited material is thickest, and the ratio T/Tmax of the film thickness T in surrounding locations, with the film thickness Tmax defined as 100%.

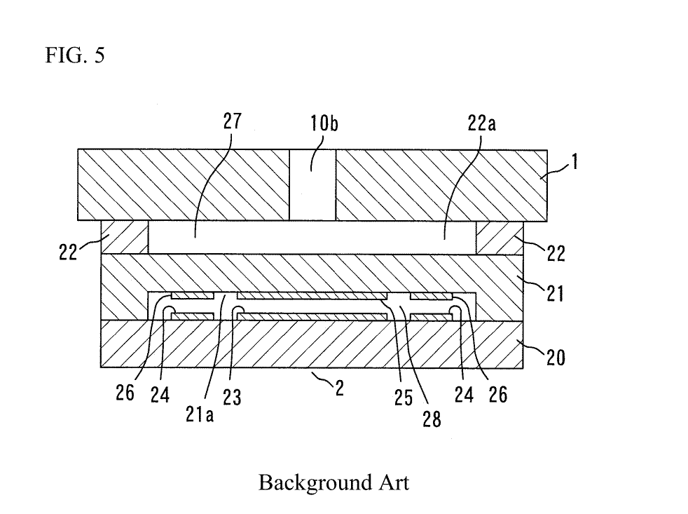

The rate of shift of the sensor output is expressed as a rate of shift of the sensor output for the electrostatic pressure sensor according to the present example relative to the sensor output of a conventional electrostatic pressure sensor. Here the structure of the conventional electrostatic pressure sensor used for the comparison was as shown in FIG. 5. In FIG. 5, structures that are identical to those in FIG. 1 are assigned identical codes. As illustrated in FIG. 5, in the conventional electrostatic pressure sensor a pressure introducing hole 10b is formed at the position of the center of the diaphragm 21. The area of the pressure introducing hole 10b is equal to the total area of the four pressure introducing hole 10. In contrast to the conventional electrostatic pressure sensor wherein the deposited material is the thickest in the vicinity of the center of the diaphragm 21, which is directly under the pressure introducing hole 10b, in the present example the deposited material is thickest directly under the pressure introducing holes 10, which are further toward the outside than the center of the diaphragm 21.

When the sensor output of the conventional electrostatic pressure sensor is defined as KO when no pressure is applied to the diaphragm 21, and, similarly, the sensor output of the electrostatic pressure sensor according to the present example is defined as K1 when no pressure is applied to the diaphragm 21, the sensor output shift rate SR is calculated as given in the following equation:

SR=(K1−K0)/K0 (2).

Note that if there were uniform deposition on the diaphragm of the conventional electrostatic pressure sensor of FIG. 5, then the sensor output shift rate SR would be 100%.

FIG. 4 shows the improvement in the zero-point shift, relative to that of the conventional electrostatic pressure sensor, when the sensor output shift rate SR is in a range between -100% and 100%. The sensor output shift rate SR is in the range of −100% and 100% when the center positions for the pressure introducing holes 10 are in the range of between 50.0% and 70.0% from the center of the diaphragm 21. Consequently, it is understood that setting the center positions of the individual pressure introducing holes 10 in the range of 50.0% through 70.0% from the center of the diaphragm 21 can suppress the zero-point shift.

This quantitative range being good can be assumed to be due to the following reasons. In the conventional electrostatic pressure sensor, the flexure or of the diaphragm 21 was large due to the deposited material because the deposited material was thickest in the vicinity of the center of the diaphragm 21. The effect of the flexure could not be canceled out through performing the calculation shown in Equation (1).

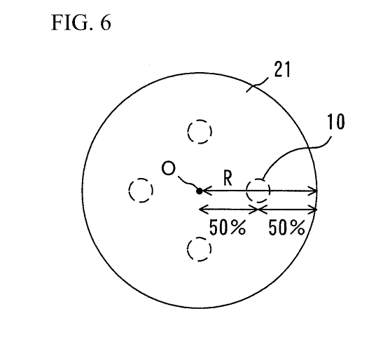

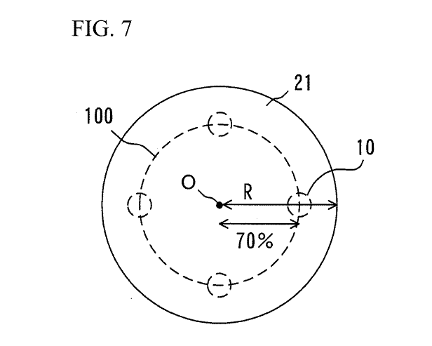

As a specific method for controlling the film thickness distribution, the center positions of the pressure introducing holes 10 may be set to locations that are 50.0% from the center O of the diaphragm 21, as illustrated in FIG. 6. This method is a method wherein the distance from the center O of the diaphragm 21 to the pressure introducing holes 10 and the distance from the pressure introducing holes 10 to the edge of the diaphragm 21 are equal. As another controlling method, the center positions of the pressure introducing holes 10 may be set to locations that are 70.0% from the center O of the diaphragm 21, as illustrated in FIG. 7. This method is a method wherein the area of the circle 100 that is further toward the inside from the pressure introducing holes 10 is equal to the area of the diaphragm 21 less the area of the circle 100. This method, theoretically, forms a desirable shape for the film thickness distribution on the diaphragm 21.

Even in the present example, the thickness of the deposited material is greatest directly under the pressure introducing holes 10, but even with such a bias in the film thickness, the effect on the flexure of the diaphragm 21, caused by the bias in the film thickness, can be canceled out by the calculation shown in Equation (1).

Described above, in the present example, the centers of the pressure introducing holes 10 are located in the range of 50.0% through 70.0% from the center of the diagram 21, thus enabling suppression of the zero-point shift of the electrostatic pressure sensor even when the electrostatic pressure sensor is applied to a device that uses a film deposition technique that produces a bias in the film thickness distribution on the diaphragm, such as ALD.

The present invention enables a pressure sensor chip of a diaphragm structure to be applied to an electrostatic pressure sensor.

1. An electrostatic pressure sensor comprising:
a diaphragm having a center portion that dislocates in accordance with a pressure of a medium to be measured;
a sensor pedestal that secures a peripheral edge portion of the diaphragm, to form a reference vacuum chamber in cooperation with the diaphragm;
a cover plate, bonded to an outer peripheral portion of the diaphragm on the opposite side from the sensor pedestal, to form a pressure introduction chamber in cooperation with the diaphragm;
a stationary electrode that is formed on a surface of the sensor pedestal on the reference vacuum chamber side; and
a movable electrode that is formed on a surface of the diaphragm on the reference vacuum chamber side, facing the stationary electrode, wherein
the cover plate has a pressure introducing hole that introduces the medium to be measured into the pressure introduction chamber from a direction that is perpendicular to the surface of the diaphragm, and
the pressure introducing hole is arranged so as to be positioned in a range of between 50.0% and 70.0% from the center of the diaphragm along a direction of the surface of the diaphragm, when the radius of the diaphragm is defined as 100%.

2. The electrostatic pressure sensor as set forth in claim 1, wherein
the pressure introducing hole is arranged in a plurality of holes in positions on a circle that encompass the center of the diaphragm.

3. The electrostatic pressure sensor as set forth in claim 1, wherein
the movable electrode comprises
a pressure sensing side movable electrode that is formed so that the center thereof is coincident with the center of the diaphragm, and
a reference side movable electrode that is formed so as to be to the outside of the pressure sensing side movable electrode, and
the stationary electrode comprises
a pressure sensing side stationary electrode that is formed so as to face the pressure sensing side movable electrode, and
a reference side stationary electrode that is formed so as to face the reference side movable electrode.
